(19) United States
(12) Patent Application Publication
(10) Pub. No.: US 2015/0248659 A1
(43) Pub. Date: Sep. 3, 2015

(54) PRODUCT INFORMATION PRINT DEVICE AND PRODUCT INFORMATION PRINT SYSTEM

(71) Applicants: KABUSHIKI KAISHA TOSHIBA, Tokyo (JP); TOSHIBA TEC KABUSHIKI KAISHA, Tokyo (JP)

(72) Inventor: Tsutomu UETA, Yaizu Shizuoka (JP)

(21) Appl. No.: 14/617,835

(22) Filed: Feb. 9, 2015

(30) Foreign Application Priority Data
Feb. 28, 2014 (JP) 2014-038754

(51) Int. Cl. G06Q 20/20

(52) U.S. Cl. CPC G06Q 20/209

(57) ABSTRACT

According to embodiments, a product information print device comprises a controller. The controller acquires purchased product detail data from a shop management server for collecting transaction data from an account processing terminal via a communication unit. The control unit further creates a purchased product detail list based on the purchased product detail data, and a print format and print items, and prints the purchased product detail list on a sheet by use of a print unit.

### CROSS-REFERENCE TO RELATED APPLICATION

This application is based upon and claims the benefit of priority from the prior Japanese Patent Application No. 2014-38754, filed on Feb. 28, 2014, the entire contents of which are incorporated herein by reference.

### FIELD

Embodiments described herein generally relate to a product information print device and a product information print system.

### BACKGROUND

Conventionally, when a purchaser manages a purchased object at home, the purchaser transcribes the purchased object data to a housekeeping book with reference to a receipt issued from a cash register on purchase in many cases. Alternatively, the purchaser attaches a receipt on a notebook in many cases. The purchaser takes some to do the manual work. Therefore, there is devised a solution in which a server installed in a shop or the like stores purchased object data and a purchaser accesses the server at home via Internet to acquire the purchased object data. Further, there is devised a solution in which a cash register prints a management number barcode on a receipt and a purchaser reads the barcode by use of a camera mounted on his/her cell phone to acquire the purchased object data from the server via Internet.

In order to manage a purchased object by use of a conventional technique, however, it is assumed that a connection environment for Internet and an equipment environment for personal computer or cell phone are set at a purchaser and electronic data is used for purchased object data. Therefore, when a purchaser who does not have or cannot use an information terminal such as personal computer manages a purchased object, he/she has to attach a receipt on a notebook or transcribe the purchased object data on a notebook with reference to a receipt as before.

### BRIEF DESCRIPTION OF THE DRAWINGS

FIG. 1 is a block diagram illustrating an exemplary entire structure of a product information print system according to a first embodiment;

FIG. 2 is a diagram illustrating a specific example of a print setting screen displayed on a display panel used in the product information print system according to the first embodiment;

FIG. 3 is a diagram illustrating a specific example of a purchased product detail list output by a print unit used in the product information print system according to the first embodiment;

FIG. 4 is a flowchart illustrating exemplary processings by a POS terminal used in the product information print system according to the first embodiment;

FIG. 5 is a flowchart illustrating exemplary processings by a shop management server used in the product information print system according to the first embodiment;

FIG. 6 is a flowchart illustrating exemplary processings by a product information print device used in the product information print system according to the first embodiment;

FIG. 7 is a block diagram illustrating an exemplary entire structure of a product information print system according to a second embodiment;

FIG. 8 is a flowchart illustrating exemplary processings by the product information print device used in the product information print system according to the second embodiment;

FIG. 9 is a block diagram illustrating an exemplary entire structure of a product information print system according to a third embodiment;

FIG. 10 is a flowchart illustrating exemplary processings by a shop management server used in the product information print system according to the third embodiment; and

FIG. 11 is a flowchart illustrating exemplary processings by the product information print device used in the product information print system according to the third embodiment.

### DETAILED DESCRIPTION

According to one embodiment, a product information print device comprises a communication unit, a card read unit, a display panel, an operation unit, a controller, and a print unit. The communication unit makes communication with a shop management server. The shop management server collects transaction data including purchaser identification data for specifying a purchaser who purchases a product from an account processing terminal. The shop management server generates purchased product detail data based on the collected transaction data and product data previously stored in association with product identification data for specifying a product. The card read unit reads member identification data for specifying a member from a member card owned by the purchaser. The display panel displays a print setting screen including a print format and print items for printing a purchased product detail list based on the purchased product detail data. The operation unit receives the print format and print items, selected by the purchaser, included in the print setting screen on the display panel. The controller transmits the read member identification data to the shop management server via the communication unit. The controller further acquires the purchased product detail data from the shop management server via the communication unit. The purchased product detail data acquired from the shop management server is generated by the shop management server based on the transaction data including the purchaser identification data matching with the transmitted member identification data, and the product data associated with the product identification data included in the transaction data. The controller further creates a purchased product detail list from the acquired purchased product detail data based on the received print format and print items. The print unit prints the purchased product detail list created by the controller on a sheet.

Other embodiment(s) will be described below with reference to the drawings. The same reference numerals indicate the same or like parts in the drawings.

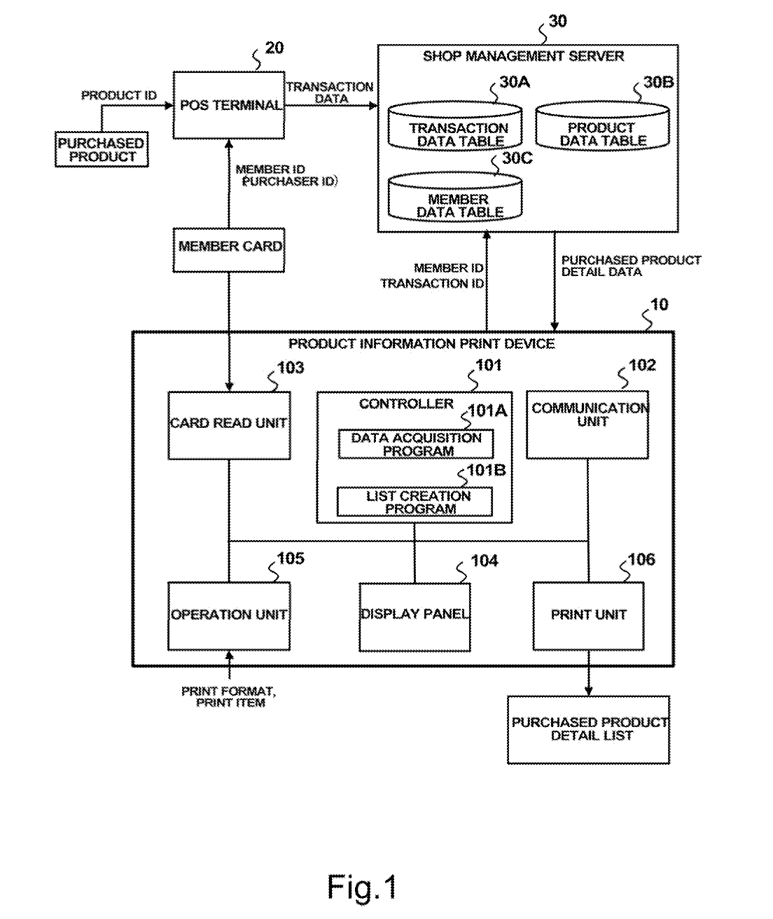

A first embodiment will be described with reference to FIG. 1. FIG. 1 is a block diagram illustrating a product information print system according to the first embodiment. As illustrated in FIG. 1, the product information print system includes a product information print device 10, a POS (Point Of Sale) terminal 20, and a shop management server 30. The product information print device 10, the POS terminal 20 and the shop management server 30 are connected to each other via a network (not illustrated) such as LAN (Local Area Network). The devices 10, 20 and 30 are assumed to be installed in the same shop.

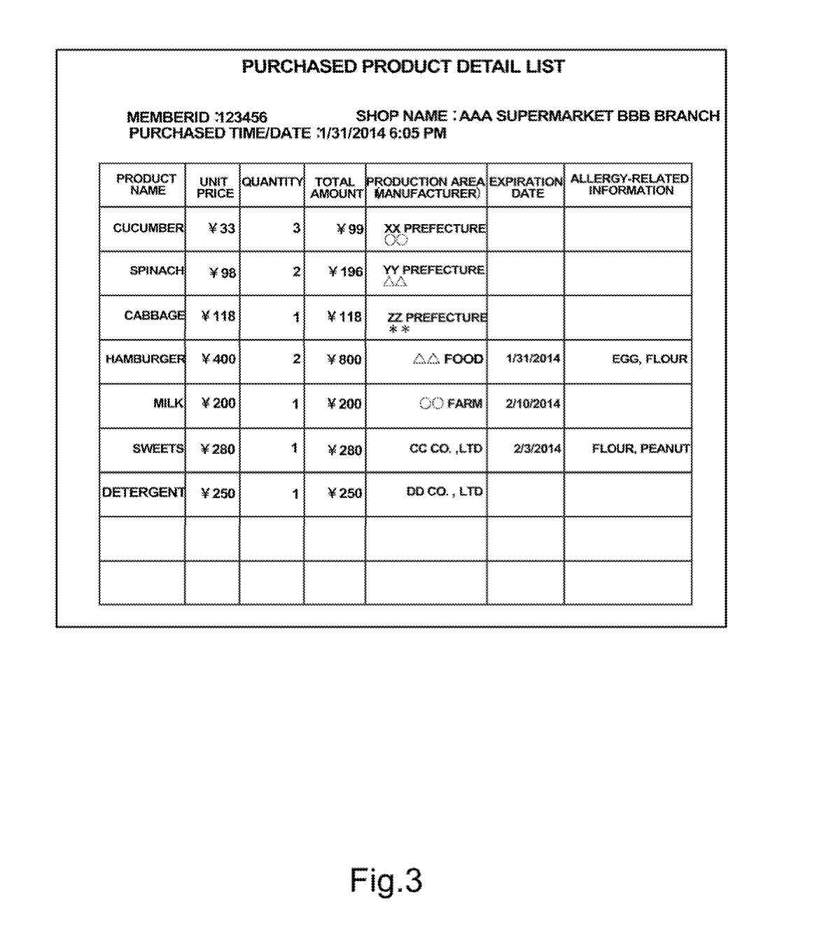

The product information print device 10 downloads purchased product detail data described later from the shop management server 30 in response to a request from a shopper (which will be called purchaser below). The product information print device 10 prints a purchased product detail list (see FIG. 3 described later) based on the downloaded purchased product detail data on a sheet. The product information print device 10 is a MFP (Multi-Function Peripheral) device or the like, for example. The purchased product detail list describes therein product detail information (which will be called product data below) not described on a typical receipt. The product data includes expiration date, allergy-related information, production area, pesticide use, production date, message from a producer and the like, for example. The POS terminal 20 is directed for performing an account processing when a purchaser purchases a product or is serviced. The POS terminal 20 outputs a result of the account processing as transaction data to the shop management server 30. The transaction data is purchase history data of the purchaser. The transaction data includes purchaser identification data for specifying a purchaser. In the following, the purchaser identification data will be called purchaser ID. The transaction data further includes a transacted product and transaction detail information. The transaction detail information included in the transaction data includes transaction identification data, product identification data, and data on product name, purchase unit price, purchased quantity, purchase time/date (transaction time/date), subtotal of each product, total amount of transaction, amount received from purchaser, and the like, for example. The transaction identification data is directed for specifying a transaction. The transaction identification data will be called transaction ID below. The product identification data is directed for specifying a product. The product identification data will be called product ID below. The shop management server 30 collects the transaction data from all the POS terminals 20 in a shop in real-time. The shop management server 30 performs a statistical processing on the collected transaction data. The shop management server 30 is an information management server such as server computer for managing transaction data subjected to the statistical processing in a database after performing the statistical processing.

As illustrated in FIG. 1, the product information print device 10 comprises a controller 101, a communication unit 102, a card read unit 103, a display panel 104, an operation unit 105, and a print unit 106. The controller 101 is a control unit mounting thereon a computing device such as CPU (Central Processing Unit) and storage devices such as ROM (Read Only Memory) and RAM (Random Access Memory). The controller 101 executes various programs installed in the storage devices thereby to control the entire product information print device 10. The controller 101 executes a data acquisition program 101A and a list creation program 101B installed in the storage devices, for example.

The data acquisition program 101A is executed by the controller 101 in order to transmit member identification data of a member card read by the card read unit 103 to the shop management server 30 via the communication unit 102 and to acquire purchased product detail data from the shop management server 30. The member card is issued by the shop to a person who takes a predetermined procedure. The member card stores the member identification data therein. The member identification data is directed for specifying a member. The member identification data will be simply called member ID below. In other words, the controller 101 executes the data acquisition program 101A to read a member ID of the member card by use of the card read unit 103. The controller 101 executes the data acquisition program 101A to transmit the read member ID to the shop management server 30 by use of the communication unit 102. The controller 101 executes the data acquisition program 101A to acquire the purchased product detail data from the shop management server 30 by use of the communication unit 102. The purchased product detail data is generated by the shop server 30 based on the transaction data including a purchaser ID matching with the member ID, and the product data previously associated with the product ID included in the transaction data. In the following description, transaction data including a purchaser ID will be called transaction data with a purchaser ID. The list creation program 101B is executed by the controller 101 in order to create a purchased product detail list from the purchased product detail data based on a print format and print items selected by the purchaser via the operation unit 105. In other words, the controller 101 executes the list creation program 101B to receive a print format and print items selected by the purchaser by use of the operation unit 105. The controller 101 executes the list creation program 101B thereby to create a purchased product detail list from the purchased product detail data based on the selected print format and print items.

The communication unit 102 is a communication device for making communication with the shop management server 30. The card read unit 103 is an input device for reading the member ID of the member card. According to the present embodiment, the member ID is assumed to be set as the purchaser ID included in the transaction data during the account processing at the POS terminal 20.

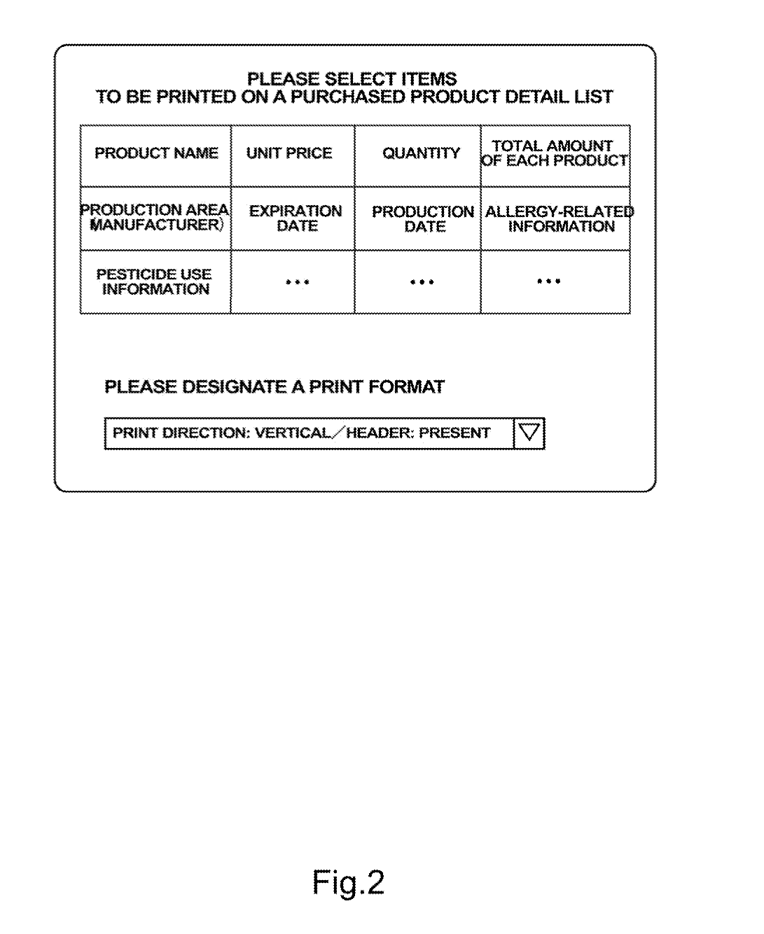

The display panel 104 is a display device for displaying an operation screen such as print setting screen for printing a purchased product detail list based on the purchased product detail data. The print setting screen displayed on the display panel 104 will be described with reference to FIG. 2. FIG. 2 is a diagram illustrating a specific example of the print setting screen. The print setting screen displays thereon the print items for printing a purchased product detail list based on purchased product detail data, and a print format. As illustrated in FIG. 2, the print items include data items such as product name, unit price of purchased product, purchased quantity, total amount of each purchased product, production area or manufacturer of purchased product, expiration date of purchased product, production date of purchased product, allergy-related information of purchased product, and pesticide use information of purchased product. The print setting screen displays thereon a guidance message for promoting a purchaser to select print items, such as a character string “please select items to be printed on a purchased product detail list” together with the print items. In other words, the print setting screen displays the print items and the guidance message thereon in order to enable the purchaser to arbitrarily select items to be printed on a purchased product detail list from the print items. Additionally, as illustrated in FIG. 2, the print format includes a print direction (vertical or horizontal) and the presence of a header. The print setting screen displays thereon an instruction message for promoting a purchaser to designate a print format, such as a character string “please designate a print format” together with the print format. The print setting screen in FIG. 2 indicates a character string “print direction: vertical/header: present” indicating that the printing direction is vertical and the header is present as a designated status of the current print format. In FIG. 2, an icon button indicated by a ∇ mark accepts a touch operation by the purchaser so that a designated status of the print format to be displayed is changed. In other words, the purchaser operates the icon button thereby to designate any of “print direction: vertical/header: absent”, “print direction: horizontal/header: present”, and “print direction: horizontal/header: absent” as a print format in addition to the above designated status. As described above, the purchaser can designate a print format according to an instruction on the print setting screen displayed on the display panel 104 in the product information print device 10. The product information print device 10 may transmit the data on the designated print format to the shop server 30 together with the member ID (purchaser ID) of the member card in order to use the print format designated by the purchaser as initial values at subsequent printing for the same member (the same purchaser). The shop server 30 stores the data on the designated print format as a member's registered print format together with the member ID in a member data table 30C.

The operation unit 105 is an input device by which a purchaser arbitrarily selects any function of the product information print device 10 thereby to operate the device. For example, the operation unit 105 receives a purchaser's operation of selecting the print format and print items displayed on the print setting screen on the display panel 104.

The print unit 106 is directed for printing a purchased product detail list created by the controller 101 which executes the list creation program 101B on a sheet. A purchased product detail list will be described with reference to FIG. 3. FIG. 3 is a diagram illustrating a specific example of a purchased product detail list to be printed by the print unit 106. As illustrated in FIG. 3, the print unit 106 prints member ID, purchaser time/date and shop name in the header based on the print format in the purchased product detail list. Further, the print unit 106 prints product name, unit price, quantity, total amount, production area (manufacturer), expiration date and allergy-related information according to the print items in the list part in the middle of the purchased product detail list. Specifically, as illustrated in FIG. 3, the character strings “member ID: 1234”, “purchase time/date: 1/31/2014 16:05 PM” and “shop name: AAA Supermarket BBB branch” are printed as member ID, purchase time/date and shop name, respectively, at the header in the purchased product detail list. Further, as illustrated in FIG. 3, the character strings “cucumber”, “spinach”, “cabbage”, “hamburger”, “milk”, “sweets” and “detergent” are printed in the list part in the middle of the purchased product detail list. Furthermore, as illustrated in FIG. 3, the character strings “XX prefecture ◯◯”, “YY prefecture ΔΔ”, “ZZ prefecture **”, “ΔΔ food”, “◯◯ farm”, “CC Co., Ltd” and “DD Co., Ltd” are printed as production area or manufacturer in the list part in the purchased product detail list. Additionally, as illustrated in FIG. 3, the character strings “egg, flour” and “flour, peanut” are printed as allergy-related information in the list part in the purchased product detail list.

The shop management server 30 has a database including a transaction data table 30A, a product data table 30B and the member data table 30C. The transaction data table 30A is directed for storing transaction data in order to manage the transaction data collected from the POS terminals 20. As described above, the transaction data includes the data items such as purchaser ID, transaction ID, product ID, product name, purchase unit price, purchased quantity, purchase time/date (transaction time/date), subtotal of each product, total amount of transaction, and amount received from purchaser. The product data table 30B is directed for storing product data in order to manage product data (products' detailed data) soled in the shop. The product data includes the data items such as product ID, product name, product classification, production area, manufacturer, expiration date, allergy-related information and pesticide use information. The product data including the product ID is previously associated with the product ID, and is stored in the product data table 30B. The member data table 30C is directed for storing member data in order to manage member information of a shop or a group of shops. The member data includes the data items such as member ID, member name, member's age, registration date, purchase points and registered print format. The data items in each table are merely exemplary, and are not limited thereto.

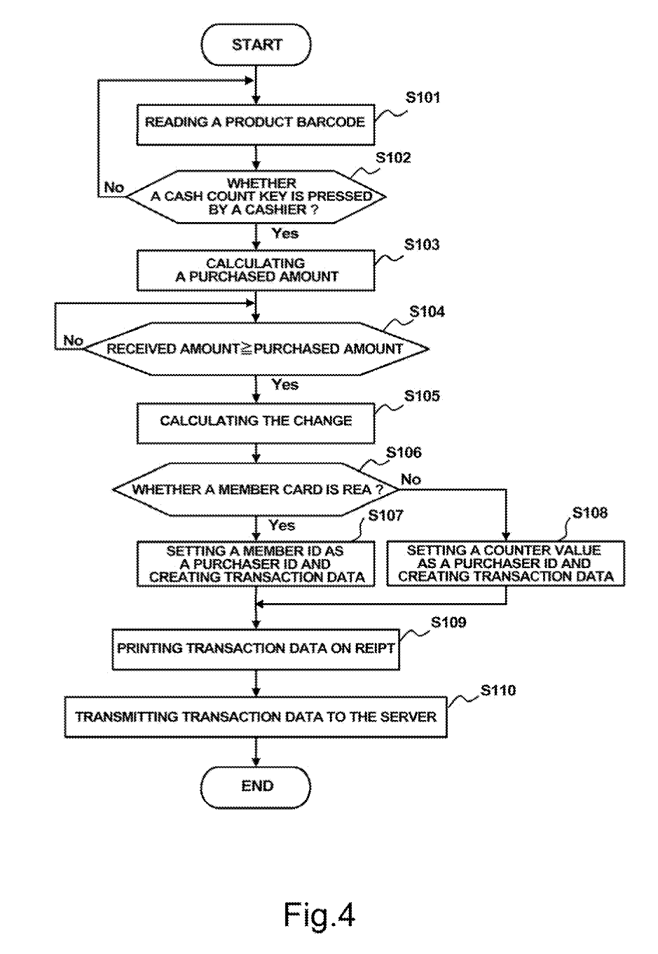

The processings in each of the devices 10, 20 and 30 in the product information print system will be described below with reference to FIG. 4 to FIG. 6. FIG. 4 is a flowchart illustrating exemplary processings by the POS terminal 20. The purchaser carries a purchased product to a cash register installed with the POS terminal 20 for the account processing. The POS terminal 20 is operated by a clerk (cashier) to perform the account processing on the purchased product. As illustrated in FIG. 4, in processing step S101, the POS terminal 20 operated by the cashier reads a barcode attached on the product by use of a scanner (not illustrated). The barcode holds data such as product ID for specifying the purchased product therein. If a barcode is not attached on the product, the clerk presses keys corresponding to each product in the keyboard (not illustrated) in the POS terminal 20 thereby to directly input a unit price or the like. In other words, the POS terminal 20 uses the keyboard to acquire the product ID corresponding to the purchased product, the unit price of the purchased product, the quantity of purchased products, and the like.

When the account processing in step S101 starts, the processing by the POS terminal 20 proceeds to step S102. In step S102, the POS terminal 20 determines whether a cash count key (not illustrated) included in the keyboard is pressed by the cashier. When the POS terminal 20 determines that the cash count key (not illustrated) is pressed by the cashier (Yes in S102), the processing by the POS terminal 20 proceeds to step S103. In step S103, the POS terminal 20 calculates a purchased amount from the unit price of the purchased product and the quantity of purchased products (see S101). After the purchased amount is calculated, the processing by the POS terminal 20 proceeds to step S104. On the other hand, when the POS terminal 20 determines that the cash count key (not illustrated) is not pressed by the cashier (No in S102), the processing by the POS terminal 20 returns to step S101.

After calculating the purchased amount in step S103, the cashier receives payment for the purchased amount from the purchaser and inputs the received amount into the POS terminal 20 via the keyboard in the POS terminal 20. In step S104, the POS terminal 20 is input with the received amount by the cashier via the keyboard. Further, the POS terminal 20 determines whether the received amount is the calculated purchased amount or more. When the POS terminal 20 determines that the received amount is the purchased amount or more (Yes in S104), the processing by the POS terminal 20 proceeds to step S105. In step S105, the POS terminal 20 calculates the change and prepares the payment. On the other hand, when the POS terminal 20 determines that the received amount is less than the purchased amount (No in S104), the processing by the POS terminal 20 returns to step S104. The POS terminal 20 waits for the shortage of the received amount for the purchased amount to be paid.

After the change is calculated and the payment is prepared in step S105, the processing by the POS terminal 20 proceeds to step S106. In step S106, the POS terminal 20 determines whether the member ID of the member card is read by the card read unit 103 in the product information print device 10. When the POS terminal 20 determines that the member ID of the member card owned by the purchaser is read (Yes in step S106), the processing by the POS terminal 20 proceeds to step S107. In step S107, the POS terminal 20 sets the read member ID as a purchaser ID. The POS terminal 20 further creates transaction data including the purchaser ID (matching with the member ID), product ID of purchased product, product name, unit price, quantity, subtotal of each product, total amount, received amount, and purchaser ID. On the other hand, when the POS terminal 20 determines that the member ID of the member card is not read because the purchaser does not have a member card, for example, (No in S106), the processing by the POS terminal 20 proceeds to step S108. The cashier inputs a predetermined counter value (such as the number of transactions of the day) or a predetermined guest member ID into the POS terminal 20 via the keyboard in the POS terminal 20. In step S108, the POS terminal 20 sets the predetermined counter value or predetermined guest member ID as a purchaser ID thereby to create the transaction data.

When the transaction data is created in step S107 or step S108, the processing by the POS terminal 20 proceeds to step S109. In step S109, the POS terminal 20 prints the transaction data including the received amount and the change on a receipt. After the transaction data is printed, the processing by the POS terminal 20 proceeds to step S110. In step S110, the POS terminal 20 transmits the transaction data to the shop management server 30 and terminates the processing.

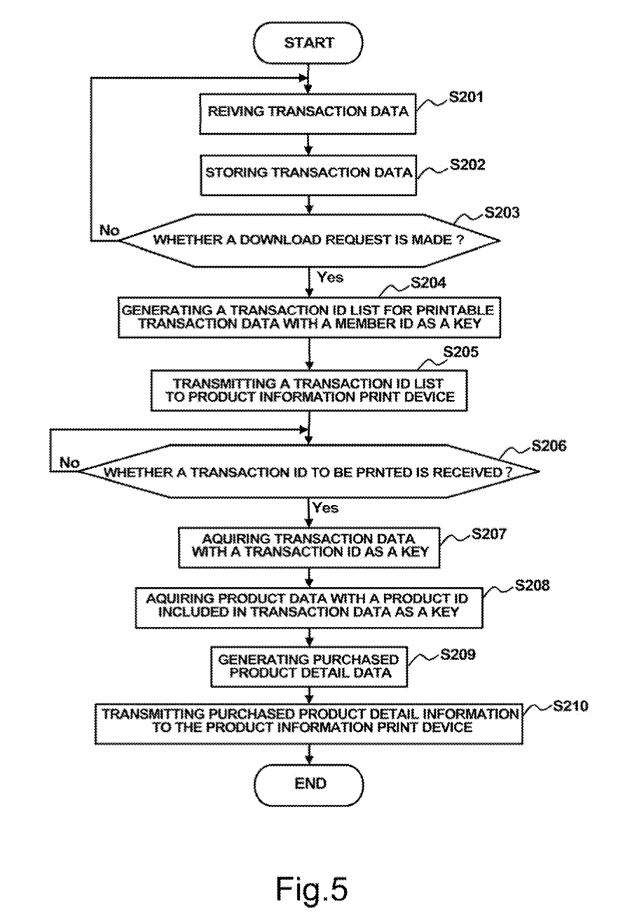

The processings by the shop management server 30 will be described below with reference to FIG. 5. FIG. 5 is a flowchart illustrating exemplary processings by the shop management server 30 according to the first embodiment.

As illustrated in FIG. 5, in processing step S201, the shop management server 30 receives the transaction data (see S110) from the POS terminal 20. After the transaction data is received, the processing by the shop management server 30 proceeds to step S202. In step S202, the shop management server 30 stores the received transaction data in the transaction data table 30A. After the transaction data is stored, the processing by the shop management server 30 proceeds to step S203.

In step S203, the shop management server 30 determines whether a request to download the purchased product detail data is received from the product information print device 10. Specifically, for example, the shop management server 30 determines whether the member ID (purchaser ID) transmitted from the product information print device 10 is received for a request to download the purchased product detail data (see processing step S302 by the product information print device 10 described later). When the shop management server 30 determines that a request to download the purchased product detail data is received (the member ID is received) (Yes in S203), the processing by the shop management server 30 proceeds to step S204. On the other hand, when the shop management server 30 determines that a request to download the purchased product detail data is not received (the member ID is not received) (NO in S203), the processing by the shop management server 30 returns to step S201. Further, in step S204, the shop management server 30 acquires the transaction ID for printable transaction data with the purchaser ID matching with the member ID from the transaction data table 30A with the received member ID as a key. The shop management server 30 generates a transaction ID list based on the acquired transaction ID. The printable transaction data is the transaction data (see S202) stored in the transaction data table 30A. When a plurality of items of transaction data with the same member ID are stored in the transaction data table 30A, the shop management server 30 may contain the transaction ID for all the transaction data in the transaction ID list, for example. Further, the shop management server 30 may determine a transaction ID to be included in the transaction ID list in consideration of a transaction data registration date (purchase date) or the number of times of past printing. Specifically, the shop management server 30 may include a transaction ID only for transaction data for which the purchase date is included in a previously-designated period for print or transaction data not using the print service in the past in the transaction ID list. After the transaction ID list is generated, the processing by the shop management server 30 proceeds to step S205. In step S205, the shop management server 30 transmits the generated transaction ID list to the product information print device 10. After the shop management server 30 transmits the transaction ID list, the product information print device 10 receives the transaction ID list in processing step S304 described later. When receiving the transaction ID list, the product information print device 10 displays the transaction ID list as candidates of the purchased product detail data to be downloaded on the display panel 104 in processing step S306 described later. Further, the product information print device receives the transaction ID selected by the purchaser, and transmits the selected transaction ID to the shop management server 30. The selected transaction ID is a so-called transaction ID for purchased product detail data which the purchaser wants to download in order to print the purchased product detail list.

After the shop management server 30 transmits the transaction ID list to the product information print device 10, the processing by the shop management server 30 proceeds to step S206. In step S206, the shop management server 30 determines whether the transaction ID for the purchased product information detail list selected by the purchaser is received from the product information print device 10. When the shop management server 30 determines that the transaction ID (the transaction ID for the purchased product information detail list) selected by the purchaser is received (Yes in S206), the processing by the shop management server 30 proceeds to step S207. In step S207, the shop management server 30 acquires the transaction data with the transaction ID from the transaction data table 30A with the received transaction ID as a key. After the transaction data is acquired, the processing by the shop management server 30 proceeds to step S208. In step S208, the shop management server 30 acquires the product data previously associated with the product ID from the product data table 30B with the product ID included in the acquired transaction data as a key. On the other hand, when the shop management server 30 determines that the transaction ID (the transaction ID for the purchased product information detail list) selected by the purchaser is not received (No in S206), the shop management server 30 waits for the transaction ID to be received from the product information print device 10.

After the transaction data and the product data are acquired, the processing by the shop management server 30 proceeds to step S209. In step S209, the shop management server 30 generates purchased product detail data from the transaction data and the product data. After the purchased product detail data is generated, the processing by the shop management server 30 proceeds to step S210. In step S210, the shop management server 30 transmits the generated purchased product detail data to the product information print device 10 in response to the download request (see S203), and terminates the processing.

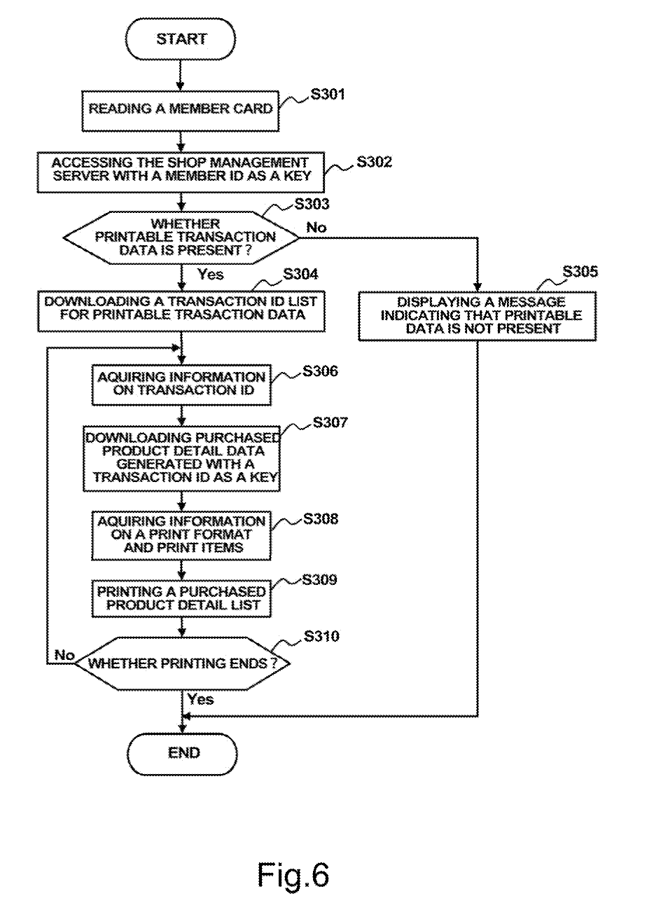

The processings by the product information print device 10 will be described below with reference to FIG. 6. FIG. 6 is a flowchart illustrating exemplary processings by the product information print device 10 according to the first embodiment. The processings by the product information print device 10 illustrated in FIG. 6 are performed when a purchaser who finishes payment prints a purchased product detail list by use of a member card.

As illustrated in FIG. 6, in processing step S301, the controller 101 in the product information print device 10 reads the member ID recorded in the member card owned by the purchaser by use of the card read unit 103. After the member ID is read, the processing by the product information print device 10 proceeds to step S302. In step S302, the controller 101 accesses the shop management server 30 with the read member ID as a key. Specifically, the controller 101 transmits the read member ID to the shop management server 30 by use of the communication unit 102 in order to request the shop management server 30 to download the product information detail data.

After the product information print device 10 accesses the shop management server 30 for the download request, as described above, the shop management server 30 acquires the transaction ID included in the printable transaction data with the purchaser ID matching with the member ID from the transaction data table 30A, and generates a transaction ID list (see S204). Further, the shop management server 30 transmits the transaction ID list to the product information print device 10 as described above (see S205). After an access is made to the shop management server 30 in step S302, the processing by the product information print device 10 proceeds to step S303. In step S303, the controller 101 in the product information print device 10 determines whether printable transaction data with the purchaser ID matching with the member ID is stored in the transaction data table 30A in the shop management server 30. Specifically, the controller 101 determines whether the transaction ID list for the printable transaction data transmitted from the shop server 30 is received. When the controller 101 determines that printable transaction data with the purchaser ID matching with the member ID is stored in the transaction data table 30A (the transaction ID list is received) (Yes in S303), the processing by the product information print device 10 proceeds to step S304. In step S304, the controller 101 downloads the transaction ID list including the transaction ID for the printable transaction data. After the transaction ID list is downloaded, the processing by the product information print device 10 proceeds to step S306. On the other hand, when the controller 101 determines that printable transaction data with the purchaser ID matching with the member ID is not stored in the transaction data table 30A (the transaction ID list is not received) (No in S303), the processing by the product information print device 10 proceeds to step S305. In step S305, the controller 101 displays a message indicating that printable transaction data is not present by use of the display panel 104, and terminates the processing.

To the contrary, in step S306, the controller 101 in the product information print device 10 displays the transaction ID list (see S304) downloaded from the shop management server 30 by use of the display panel 104. The purchaser operates the operation unit 105 to select the transaction ID for the purchased product detail list which he/she wants to print from the transaction ID list displayed on the display panel 104. The controller 101 receives the transaction ID selected by the purchaser by use of the operation unit 105, and acquires information on the transaction ID for the purchased product detail data.

After the information on the transaction ID selected by the purchaser is acquired, the processing by the product information print device 10 proceeds to step S307. In step S307, the controller 101 transmits a request to download the purchased product detail data with the selected transaction ID to the shop server 20. After the download request is transmitted, the controller 101 executes the data acquisition program 101A to download the purchased product detail data (see step S209 and step S210) generated by the shop management server 30 with the transaction ID as a key.

After the purchased product detail data is downloaded, the processing by the product information print device 10 proceeds to step S308. In step S308, the controller 101 displays the print setting screen for printing the purchased product detail list by use of the display panel 104 (see FIG. 2). The purchaser operates the operation unit 105 to select the print format and print items on the print setting screen displayed on the display panel 104. The controller 101 receives the print format and print items selected by the purchaser by use of the operation unit 105, and acquires information on the print format and print items selected by the purchaser.

After the information on the print format and print items is acquired, the processing by the product information print device 10 proceeds to step S309. In step S309, the controller 101 edits the purchased product detail data (see S307) based on the print format and print items acquired in step S308 thereby to create a purchased product detail list. Further, the controller 101 prints the created purchased product detail list on a sheet by use of the print unit 106.

After the purchased product detail list is printed, the processing by the product information print device 10 proceeds to step S310. In step S310, the controller 101 determines whether an instruction to terminate printing or an instruction to continue printing by the purchaser is received on the operation screen displayed on the display panel 104, for example. When the controller 101 determines that an instruction to terminate printing by the purchaser is received (Yes in S310), the processing by the product information print device 10 ends. When the controller 101 determines that an instruction to continue printing is received (No in S310), the processing by the product information print device 10 returns to step S306.

Also when a connection environment for Internet and an equipment environment for personal computer or the like are not set at a purchaser, the product information print system according to the first embodiment described above can print purchased product detail information such as expiration date and production area, not generally printed on a receipt, as a purchased product detail list on a sheet. Therefore, the product information print system can provide the purchaser with purchased product detail information. The purchaser collects the sheets on which the purchased product detail lists are printed, thereby using the purchased product detail lists as a housekeeping book. Further, the product information print system is configured to select the print format and print items desired by the purchaser when printing a purchased product detail list, thereby printing the purchased product detail list according to the needs of the purchaser.

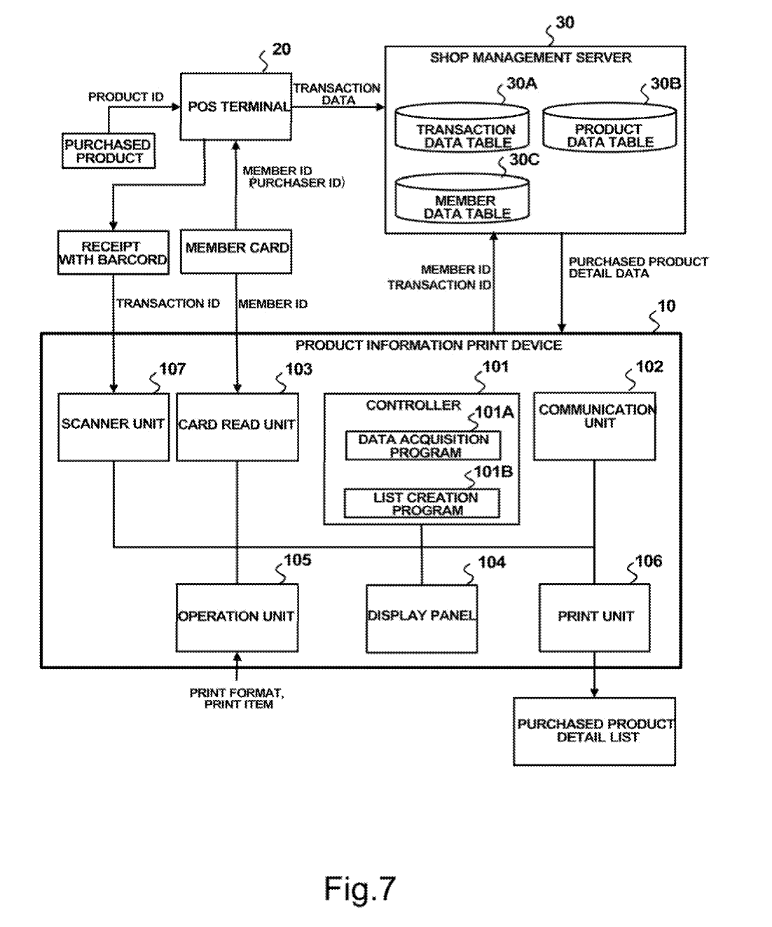

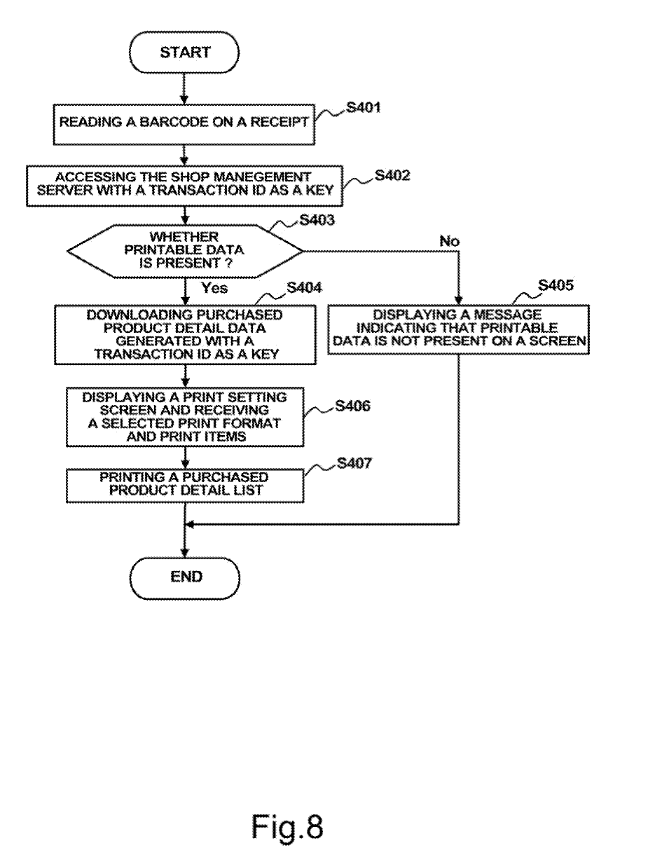

A second embodiment will be described below with reference to FIG. 7 and FIG. 8. FIG. 7 is a block diagram illustrating an exemplary entire structure of a product information print system according to the second embodiment. The same reference numerals as the reference numerals denoted in FIG. 1 indicate the same parts as the first embodiment. As illustrated in FIG. 7, the product information print device 10 in the product information print system according to the second embodiment is different from the first embodiment in that a scanner unit 107 is further provided. The processings by the POS terminal 20 and the shop management server 30 are the same as the first embodiment. Therefore, the description of the same parts as the first embodiment will be omitted in the following description, and different parts from the first embodiment will be described in detail.

According to the first embodiment, the controller 101 in the product information print device 10 reads the member ID from the member card by use of the card read unit 103 in order to determine the transaction ID for the purchased product detail list to be printed by the product information print device 10 (see step S306). To the contrary, according to the second embodiment, the POS terminal 20 prints a barcode which is the converted transaction ID on a receipt. Further, the product information print device 10 reads the barcode printed on the receipt by use of the scanner unit 107 to acquire the transaction ID for the purchased product detail list to be printed. Specifically, the controller 101 in the product information print device 10 executes the data acquisition program 101A to acquire the transaction ID from the barcode read by the scanner unit 107, and transmits the acquired transaction ID to the shop management server 30 by use of the communication unit 102. In response thereto, the shop management server 30 receives the transmitted transaction ID as a request to download the purchased product detail data as described in step S206. Further, the shop management server 30 performs the processings in steps S207 to S209 thereby to generate purchased product detail data based on the transaction data with the transaction ID, and the product data previously associated with the product ID included in the transaction data. The controller 101 in the product information print device 10 acquires the purchased product detail data.

The processings by the product information print device 10 will be described below in more detail with reference to FIG. 8. FIG. 8 is a flowchart illustrating exemplary processings by the product information print device 10 according to the present embodiment. The processings by the product information print device 10 illustrated in FIG. 8 are performed when the purchaser who finishes payment wants to print a purchased product detail list by use of a receipt with a barcode.

As illustrated in FIG. 8, in processing step S401, the controller 101 in the product information print device 10 reads a barcode on a receipt owned by the purchaser by use of the scanner unit 107. The controller 101 reads the barcode to acquire the transaction ID recorded as the barcode on the receipt. After the transaction ID is acquired, the processing by the product information print device 10 proceeds to step S402. In step S402, the controller 101 accesses the shop server 30 with the acquired transaction ID as a key. Specifically, the controller 101 transmits the transaction ID to the shop server 30 in order to request to download the purchased product detail data.

To the contrary, after the product information print device 10 accesses the shop management server 30, when the transaction data with the transaction ID is stored in the transaction data table 30A in the shop management server 30 in steps S206 to S210, the shop management server 30 acquires the transaction data with the transaction ID from the transaction data table 30A with the transaction ID as a key. Further, the shop management server 30 acquires the product data previously associated with the product ID from the product data table 30B with the product ID included in the transaction data as a key. The shop management server 30 generates purchase product detail data based on the acquired transaction data and product data. The shop management server 30 transmits the generated purchased product detail data to the product information print device 10. On the other hand, after an access is made to the shop server 30 in step S402, the processing by the product information print device 10 proceeds to step S403. In step S403, the controller 101 in the product information print device 10 determines whether the transaction data with the transaction ID is stored in the transaction data table 30A in the shop server 30. Specifically, for example, the controller 101 determines whether the purchased product detail data transmitted from the shop management server 30 is received. When the controller 101 determines that the transaction data with the transaction data is stored (the purchased product detail data is received) (Yes in S403), the processing by the product information print device 10 proceeds to step S404. On the other hand, when the controller 101 determines that the transaction data with the transaction ID is not stored (the purchased product detail data is not received) (No in S403), the processing by the product information print device 10 proceeds to step S405. In step S405, the controller 101 displays a message indicating that printable purchased product detail data is not present by use of the display panel 104, and terminates the processing.

To the contrary, in step S404, the controller 101 downloads the purchased product detail data generated by the shop management server 30 with the transaction ID as a key.

After the purchased product detail data is downloaded, the processing by the product information print device 10 proceeds to step S406. In step S406, the controller 101 displays the print setting screen (see FIG. 2) by use of the display panel 104. Further, the controller 101 receives the print format and print items selected by the purchaser by use of the operation unit 105, thereby to acquire information on the print format and print items selected by the purchaser.

After the information on the print format and print items is acquired, the processing by the product information print device 10 proceeds to step S407. In step S407, the controller 101 in the product information print device 10 edits the purchased product detail data based on the print format and print items selected by the purchaser thereby to create a purchased product detail list. The controller 101 prints the created purchased product detail list on a sheet by use of the print unit 106, and terminates the processing.

With the product information print system according to the second embodiment, in addition to the effects of the first embodiment, even a purchaser who does not have a member card can print a purchased product detail list by use of a receipt with a barcode output from the POS terminal 20.

As a variant of the second embodiment, the product information print device 10 may not comprise the card read unit 103. In this case, a control program may be only installed in the existing MFP and the right to access the shop management server 30 may be only set in the MFP.

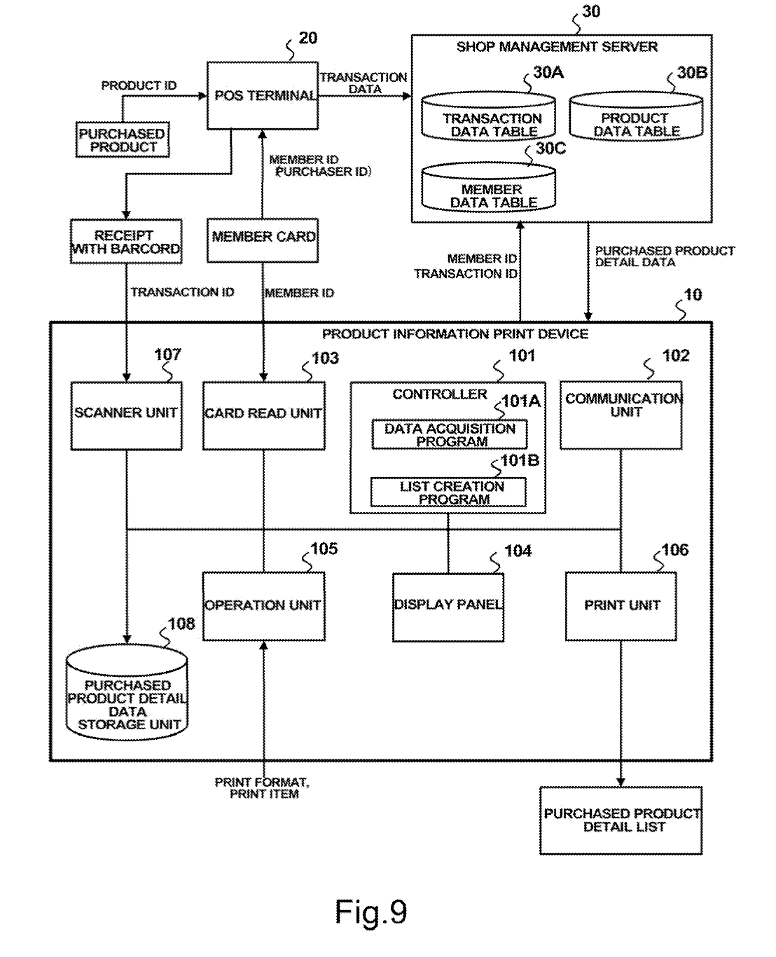

A third embodiment will be described below with reference to FIGS. 9 to 11. FIG. 9 is a block diagram illustrating an exemplary entire structure of a product information print system according to the third embodiment. As illustrated in FIG. 9, the product information print device 10 according to the third embodiment is different from the second embodiment in that a purchased product detail data storage unit 108 is provided. The same reference numerals as the reference numerals denoted in FIG. 1 and FIG. 7 indicate the same parts. The processings by the POS terminal 20 are the same as the first and second embodiments. Therefore, in the following description, different parts from the first and second embodiments will be described in detail.

According to the third embodiment, the transaction data received by the shop management server 30 from the POS terminal 20 includes a print instruction flag. When the print instruction flag included in the transaction data received from the POS terminal 20 is set to be enabled, the shop management server 30 generates purchased product detail data in real-time based on the transaction data with the purchaser ID, and the product data previously associated with the product ID included in the transaction data. In the following description, the enabled state will be simply called ON. To the contrary, the disabled state will be called OFF. Further, the shop management server 30 transmits the generated purchased product detail data together with the registered print format previously stored in association with the purchaser ID in the member data table 30C to the product information print device 10. A method for setting a print instruction flag included in transaction data ON is not limited. For example, the print instruction flag may be previously set ON in the card when the member card is issued. Further, for example, the print instruction flag may be set ON by a cashier via the keyboard on payment in response to a request from the purchaser.

The product information print device 10 executes the data acquisition program 101A to acquire the purchased product detail data and the registered print format from the shop server 30 by use of the communication unit 102. The product information print device 10 stores the acquired purchased product detail data and registered print format in a mutually-associated manner in the purchased product detail data storage unit 108. Therefore, the product information print information 10 according to the third embodiment accumulates the purchased product detail data received from the shop server 30 in the device without requesting the shop management server 30 to download the purchased product detail data unlike the first and second embodiments.

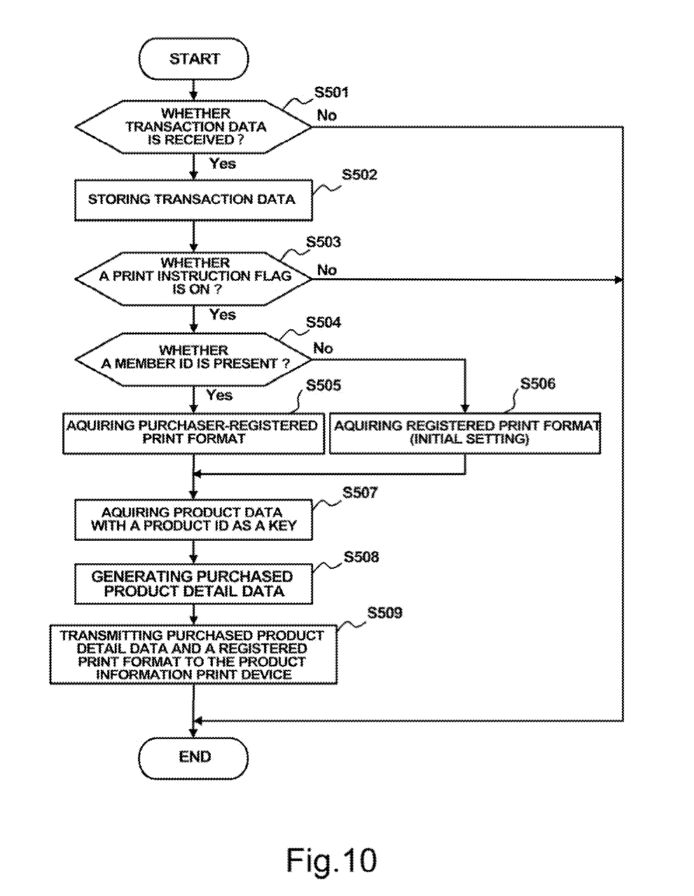

The processings by the shop management server 30 according to the third embodiment will be described below with reference to FIG. 10. FIG. 10 is a flowchart illustrating exemplary processings by the shop management server 30 according to the third embodiment. The processings by the shop management server 30 illustrated in FIG. 10 are automatically performed whenever it receives transaction data from the POS terminal 20.

As illustrated in FIG. 10, in processing step S501, the shop management server 30 determines whether the transaction data transmitted from the POS terminal 20 is received. When the shop management server 30 determines that the transaction data is received from the POS terminal 20 (Yes in S501), the processing by the shop management server 30 proceeds to step S502. In step S502, the shop management server 30 stores the received transaction data in the transaction data table 30A. On the other hand, when the shop management server 30 determines that the transaction data is not received from the POS terminal 20 (No in S501), the processing by the shop management server 30 ends.

To the contrary, after the transaction data is stored, the processing by the shop management server 30 proceeds to step S503. In step S503, the shop management server 30 analyzes the received transaction data and determines whether the print instruction flag is set ON or OFF. When the shop management server 30 determines that the print instruction flag is set ON (Yes in S503), the processing by the shop management server 30 proceeds to step S504. In step S504, the shop management server 30 determines whether the member ID matching with the purchaser ID included in the transaction data is stored in the member data table 30C. On the other hand, when the shop management server 30 determines that the print instruction flag is set OFF (No in S503), the processing by the shop management server 30 ends.

To the contrary, when the shop management server 30 determines that the member ID matching with the purchaser ID included in the transaction data is stored in the member data table 30C in step S504 (Yes in S504), the processing by the shop management server 30 proceeds to step S505. In step S505, the shop management server 30 acquires the registered print format associated with the member ID from the member data table 30C with the member ID matching with the purchaser ID as a key. After the registered print format is acquired, the processing by the shop management server 30 proceeds to step S507. On the other hand, when the shop management server 30 determines that the member ID matching with the purchaser ID is not stored in the member data table 30C (No in S504), the processing by the shop management server 30 proceeds to step S506. In step S506, the shop management server 30 acquires the initially-set registered print format. After the initially-set registered print format is acquired, the processing by the shop management server 30 proceeds to step S507.

In step S507, the shop management server 30 acquires the product data previously associated with the product ID from the product data table 30B with the product ID included in the transaction data as a key. After the product data is acquired, the processing by the shop management server 30 proceeds to step S508. In step S508, the shop management server 30 generates purchased product detail data based on the transaction data and the product data. Specifically, the shop management server 30 combines the transaction data and the product data, for example, thereby to generate purchased product detail data. After the purchased product detail data is generated, the processing by the shop management server 30 proceeds to step S509. In step S509, the shop management server 30 transmits the generated purchased product detail data to the product information print device 10. When the print format registered by the purchaser is acquired in S505, the shop management server 30 transmits the acquired registered print format together with the purchased product detail data to the product information print device 10. When the initially-set registered print format is acquired in S506, the shop management server 30 transmits the acquired initially-set and registered print format together with the purchased product detail data to the product information print device 10. After the purchased product detail data and the registered print format are transmitted, the processing by the shop management server 30 ends.

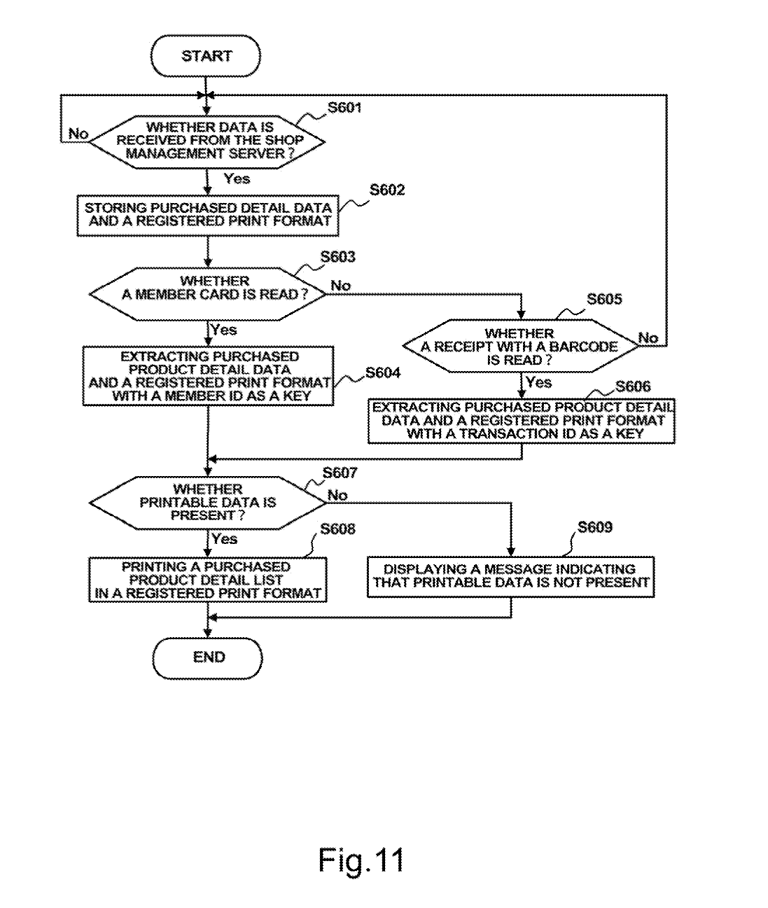

The processings by the product information print device 10 according to the third embodiment will be described below with reference to FIG. 11. FIG. 11 is a flowchart illustrating exemplary processings by the product information print device 10 according to the third embodiment.

As illustrated in FIG. 11, in processing step S601, the controller 101 determines whether the purchased product detail data and the registered print format data are received from the shop management server 30 via the communication unit 102. When the controller 101 determines that the purchased product detail data and the registered print format data are received from the shop management server 30 (Yes in S601), the processing by the product information print device 10 proceeds to step S602. In step S602, the controller 101 stores the received purchased product detail data and registered print format data in the purchased product detail data storage unit 108. On the other hand, when the controller 101 determines that the purchased product detail data and the registered print format data are not received from the shop management server 30 (No in S601), the processing by the product information print device 10 enters the standby state.

To the contrary, after the purchased product detail data and the registered print format data are stored, the processing by the product information print device 10 proceeds to step S603. In step S603, the controller 101 in the product information print device 10 determines whether the member ID of the member card is read by the card read unit 103. When the controller 101 determines that the member ID of the member card is read (Yes in S603), the processing by the product information print device 10 proceeds to step S604. In step S604, the controller 101 acquires the purchased product detail data with the purchaser ID (the purchaser ID matching with the member ID) and the registered print format from the purchased product detail data storage unit 108 with the read member ID as a key. After the purchased product detail data with the purchaser ID and the registered print format are acquired, the processing by the product information print device 10 proceeds to step S607. When the controller 101 determines that the member ID of the member card is not read (No in S603), the processing by the product information print device 10 proceeds to step S605. In step S605, the controller 101 determines that the receipt with a barcode is read by the scanner unit 107.

When the controller 101 determines that the receipt is read (Yes in S605), the processing by the product information print device 10 proceeds to step S606. In step S606, the controller 101 extracts the purchased product detail data with the transaction ID and the registered print format from the purchased product detail data storage unit 108 with the read transaction ID as a key. After the purchased product detail data and the registered print format are extracted, the processing by the product information print device 10 proceeds to step S607. On the other hand, when the controller 101 determines that the receipt is not read (No in S605), the processing by the product information print device 10 returns to step S601.

To the contrary, in step S607, the controller 101 determines whether printable purchased product detail data is stored in the purchased product detail data storage unit 108 based on the extraction result. When the controller 101 determines that printable purchased product detail data is stored in the purchased product detail data storage unit 108 (Yes in S607), the processing by the product information print device 10 proceeds to step S608. In step S608, the controller 101 acquires the purchased product detail data with the transaction ID and the registered print format from the purchased product detail data storage unit 108. The controller 101 creates a purchased product detail list in which the acquired purchased product detail data is edited based on the acquired registered print format. The controller 101 prints the created purchased product detail list on a sheet by use of the print unit 106, and terminates the processing. The print items in the purchased product detail list may be previously set or may be acquired by purchaser's selection by use of the operation unit 105 as described in step S308 or step S406.

On the other hand, when the controller 101 determines that printable purchased product detail data is not stored in the purchased product detail data storage unit 108 (No in S607), the processing by the product information print device 10 proceeds to step S609. In step S609, the controller 101 displays a message indicating that printable purchased product detail data is not present by use of the display panel 104, and terminates the processing.

With the product information print system according to the third embodiment, purchased product detail data is automatically transmitted to the product information print device 10 in a series of account processing. Therefore, when the purchaser requests to print a purchased product detail list, the product information print device 10 can rapidly print the purchased product detail list without accessing the shop management server 30 in order to request to download data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A product information print device comprising:
a communication unit configured to collect transaction data including purchaser identification data for specifying a purchaser who purchases a product from an account processing terminal, and to make communication with a shop management server for generating purchased product detail data based on the collected transaction data, and product data previously stored in association with product identification data for specifying a product;
a card read unit configured to read member identification data for specifying a member from a member card owned by the purchaser;
a display panel configured to display a print setting screen including a print format and print items for printing a purchased product detail list based on the purchased product detail data;
an operation unit configured to receive the print format and print items, selected by the purchaser, included in the print setting screen on the display panel;
a controller configured to transmit the read member identification data to the shop management server via the communication unit, to acquire the purchased product detail data generated by the shop management server based on the transaction data including purchaser identification data matching with the transmitted member identification data, and the product data associated with the product identification data included in the transaction data from the shop management server via the communication unit, and to create a purchased product detail list from the acquired purchased product detail data based on the received print format and print items; and
a print unit configured to print the purchased product detail list created by the controller on a sheet.

2. The product information print device according to claim 1, wherein the controller acquires a list of transaction identification data for specifying the product transaction, which is included in the transaction data including purchaser identification data matching with the transmitted member identification data, from the shop management server.

3. The product information print device according to claim 2, wherein the controller displays a list of the transaction identification data by use of the display panel.

4. The product information print device according to claim 3, wherein the controller receives transaction identification data selected by a purchaser from the displayed list of transaction identification data by use of the operation unit thereby to acquire transaction identification data for the purchased product detail data.

5. The product information print device according to claim 4, wherein the controller transmits the acquired transaction identification data to the shop management server, and acquires the purchased product detail data generated by the shop management server based on the transaction data for the transmitted transaction identification data, and the product data associated with the product identification data included in the transaction data.

6. The product information print device according to claim 1, further comprising:
a scanner unit configured to read the barcode on the receipt when a barcode which is obtained by converting transaction identification data included in the transaction data and directed for specifying a product transaction is printed on a receipt by the account processing terminal,
wherein the controller reads the barcode on the receipt by use of the scanner unit to acquire transaction identification data for the purchased product detail data.

7. The product information print device according to claim 6, wherein the controller transmits the acquired transaction identification data to the shop management server via the communication unit, and acquires the purchased product detail data generated by the shop management server based on the transaction data for the transmitted transaction identification data, and the product data associated with the product identification data included in the transaction data.

8. A product information print device comprising:
a communication unit configured to collect transaction data including purchaser identification data for specifying a purchaser who purchases a product from an account processing terminal, and to make communication with a shop management server for generating purchased product detail data based on the collected transaction data, and product data previously stored in association with product identification data for specifying a product;
a storage unit configured to store the purchased product detail data for the purchaser identification data, and a print format for printing a purchased product detail list based on the purchased product detail data;
a card read unit configured to read member identification data for specifying a member from a member card owed by the purchaser;
a controller configured to acquire the purchased product detail data together with the print format from the shop management server via the communication unit in real-time to store the purchased product detail data and the print format in the storage unit, and to acquire the purchased product detail data for the purchaser identification data matching with the member identification data and the print format from the storage unit to create the purchased product detail list when print instruction information included in the transaction data is set to be enabled; and
a print unit configured to print the purchased product detail list created by the controller on a sheet.

9. The product information print device according to claim 8, further comprising:
a scanner unit configured to read the barcode on the receipt when a barcode which is obtained by converting transaction identification data included in the transaction data and directed for specifying a product transaction is printed on a receipt by the account processing terminal,
wherein the controller reads the barcode on the receipt by use of the scanner unit thereby to acquire transaction identification data for the purchased product detail data.

10. The product information print device according to claim 9, wherein the controller acquires the purchased product detail data for the transaction identification data, and the print format from the storage unit with the acquired transaction identification data as a key, and creates the purchased product detail list based on the acquired purchased product detail data and print format.

11. A product information print system comprising:
an account processing terminal configured to output transaction data including purchaser identification data for specifying a purchaser who purchases a product when a product transaction is completed;
a shop management server configured to store transaction data collected from the account processing terminal, to store product data previously associated with product identification data for specifying a product, and to generate purchased product detail data based on the transaction data and the product data; and
a product information print device,
wherein the product information print device comprises:
a communication unit configured to make communication with the server;
a card read unit configured to read member identification data for identifying a member from a member card owned by the purchaser;
a display panel configured to display a print setting screen including a print format and print items for printing a purchased product detail list based on the purchased product detail data;
an operation unit configured to receive the print format and print items, selected by the purchaser, included in the print setting screen on the display panel;
a controller configured to transmit the read member identification data to the shop management server via the communication unit, to acquire the purchased product detail data generated by the shop management server based on the transaction data including purchaser identification data matching with the transmitted member identification data, and the product data associated with the product identification data included in the transaction data from the shop management server via the communication unit, and to create a purchased product detail list from the acquired purchased product detail data based on the received print format and print items; and
a print unit configured to print the purchased product detail list created by the controller on a sheet.
